(19) United States
(12) Patent Application Publication
(10) Pub. No.: US 2012/0113208 A1
(43) Pub. Date: May 10, 2012

(54) OPTICAL PRINT HEAD AND IMAGE FORMING APPARATUS

(75) Inventors: Hiroyuki ISHIKAWA, Shizuoka-ken (JP); Koji Tanimoto, Shizuoka-ken (JP); Kenichi Komiya, Kanagawa-ken (JP); Daisuke Ishikawa, Shizuoka-ken (JP); Kazutoshi Takahashi, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 13/280,173

(22) Filed: Oct. 24, 2011

Related U.S. Application Data
(60) Provisional application No. 61/406,981, filed on Oct. 26, 2010.

(51) Int. Cl. B41J 2/435

(52) U.S. Cl. 347/237

(57) ABSTRACT

An optical print head including, a first element row in which a plurality of light emitting elements aligns in a predetermined direction; a second element row in which a plurality of light emitting elements aligns in a predetermined direction, which aligns with the first element row in a direction orthogonal to the predetermined direction, and deviates in the predetermined direction with respect to the first element row; a data sorting circuit which outputs image data corresponding to an exposure region formed on a photoconductor due to light emitting of the first element row, and image data corresponding to an exposure region formed on the photoconductor due to light emitting of the second element row, at timings which are different from each other; and a driver which drives the light emitting elements in the first element row and the second element row, by receiving an output from the data sorting circuit.

### CROSS-REFERENCE TO RELATED APPLICATION(S)

This application is based upon and claims the benefit of priority from: U.S. provisional application 61/406981, filed on Oct. 26, 2010; the entire contents of which are incorporated herein by reference.

### FIELD

Embodiments described herein relate generally to an optical print head and an image forming apparatus.

### BACKGROUND

The optical print head irradiates a photoconductor with light, and forms an electrostatic latent image which corresponds to image data as a printing target on the photoconductor. An optical print head includes a plurality of light emitting elements. According to an arrangement of the plurality of light emitting elements, it is necessary to drive the plurality of light emitting elements.

### DESCRIPTION OF THE DRAWINGS

FIG. 1 is a diagram which shows the internal structure of an image forming apparatus.

FIG. 2 is a diagram which shows the appearance of an optical print head.

FIG. 3 is a diagram which shows a circuit configuration of the image forming apparatus.

FIG. 4 is a diagram which shows a circuit configuration of a data sorting circuit.

FIG. 5 is a diagram which shows a circuit configuration of a selection circuit for an odd numbered row or and even numbered row.

FIG. 6 is a diagram which shows a configuration of a serial and parallel conversion circuit which corresponds to image data of an odd numbered row.

FIG. 7 is a diagram which shows a configuration of the serial and parallel conversion circuit which corresponds to image data of an even numbered row.

FIG. 8 is a diagram which shows a configuration of an additional circuit.

FIG. 9 is a diagram which shows a configuration of a latching circuit.

FIG. 10 is a diagram which shows a timing chart at the time of an operation of a data sorting circuit.

FIG. 11 is an explanatory diagram of an arrangement of a light emitting element.

FIG. 12 is an explanatory diagram of an exposure region of a photoconductor.

FIG. 13 is a diagram which shows a relationship between image data which is input to the data sorting circuit and image data which is output from the data sorting circuit.

### DETAILED DESCRIPTION

The optical print head according to the embodiment includes a first element row, a second element row, a data sorting circuit, and a driver. The first element row has a plurality of light emitting elements which aligns in a predetermined direction. The second element row has a plurality of light emitting elements which aligns in a predetermined direction. The second element row aligns with the first element row in the direction orthogonal to a predetermined direction, and deviates in a predetermined direction with respect to the first element row. The data sorting circuit outputs image data which corresponds to the exposure region formed on the photoconductor due to the light emitting of the first element row and image data which corresponds to the exposure region formed on the photoconductor due to the light emitting of the second element row, at different timings from each other. The driver receives the output of the data sorting circuit and drives the light emitting elements in the first element row and the second element row.

The embodiment will be described with reference to drawings.

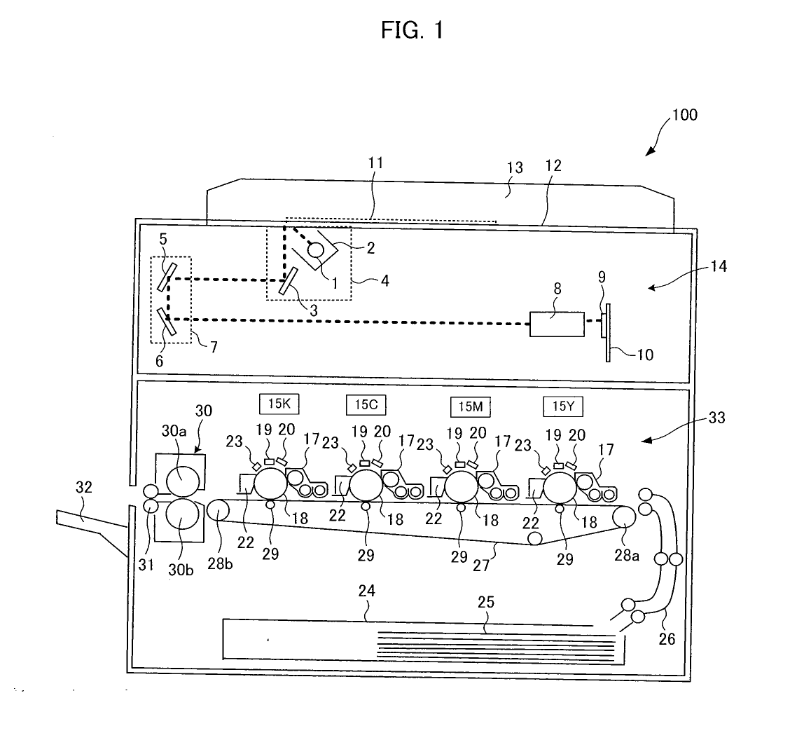

FIG. 1 is a diagram which shows the internal structure of an image forming apparatus.

The image forming apparatus 100 includes a scanner 14 and a printer 33. The scanner 14 includes a first carriage 4, a second carriage 7, a condensing lens 8, a photoelectric conversion element 9, a document table glass 12, and a document holding cover 13.

An original document 11 is placed on the document table glass 12. The document holding cover 13 presses the original document 11 on the document table glass 12. The document holding cover 13 rotates with respect to the document table glass 12, and moves between a position where the document table glass 12 is covered and a position where the document holding cover retreats from the document table glass 12.

The first carriage 4 supports a light source 1, a reflector 2, and a first mirror 3. The light source 1 emits light which illuminates the original document. The light emitted from the light source 1 passes through the document table glass 12 and reaches the original document 11.

The reflector 2 corrects the luminance intensity distribution of light which is emitted from the light source 1. Since the light which is emitted from the light source 1 is not uniform, uneven luminance intensity distribution occurs in the intensity of illumination of light which reaches the original document 11 in some cases. The reflector 2 corrects the uneven luminance intensity distribution, by reflecting the light from the light source 1 toward the original document 11.

A first mirror 3 reflects the light which is reflected on the original document 11 toward a second mirror 5. The second carriage 7 supports the second mirror 5 and a third mirror 6. The second mirror 5 reflects the light from the first mirror 3 to the third mirror 6. The third mirror 6 reflects the light from the second mirror 5 toward the condensing lens 8.

The condensing lens 8 condenses the light from the third mirror 6, and forms an image on the photoelectric conversion element 9. The photoelectric conversion element 9 is mounted to a substrate 10.

The first carriage 4 and second carriage 7 independently move in the sub-scanning direction (the horizontal direction in FIG. 1). The first carriage 4 and second carriage 7 move so that the optical path length from the original document 11 to a light receiving surface of the photoelectric conversion element 9 is maintained to be constant.

The photoelectric conversion element 9 outputs a signal which corresponds to light income. It is possible to read an image on the original document 11, by guiding the reflected light from the original document 11 to the photoelectric conversion element 9. An analog signal which is output from the photoelectric conversion element 9 is input to the optical print head 20, after being converted to a digital signal.

The printer 33 includes an image forming unit 15Y corresponding to yellow, an image forming unit 15M corresponding to magenta, an image forming unit 15C corresponding to cyan, and an image forming unit 15K corresponding to black. The image forming units 15Y to 15K have the same structures as each other.

A charging unit 19 charges the front surface of a photoconductor 18. The optical print head 20 emits light which corresponds to input image data. The light which is emitted from the optical print head 20 reaches the front surface of the photoconductor 18. The optical print head 20 exposes the front surface of the photoconductor 18, and forms an electrostatic latent image which corresponds to the image data on the front surface of the photoconductor 18. The photoconductor 18 rotates about a predetermined axis.

A developing unit 17 supplies toner on the front surface of the photoconductor 18. The developing unit 17 forms a toner image corresponding to the electrostatic latent image on the surface of the photoconductor 18. A transfer roller 29 transfers the toner image which is formed on the surface of the photoconductor 18 to a sheet 25. The sheet 25 moves along a conveying belt 27.

A sheet feeding cassette 24 receives the sheet 25. The sheet 25 moves to the printer 33 through a sheet feeding guide 26. The conveying belt 27 is hung between driving rollers 28a and 28b. When the driving rollers 28a and 28b rotate, the conveying belt 27 is moved. A cleaner 22 removes toner remaining on the front surface of the photoconductor 18. A neutralizing unit 23 neutralizes the front surface of the photoconductor 18.

The image forming unit 15Y forms a yellow toner image on the sheet 25 which moves along the conveying belt 27. The image forming unit 15M forms a magenta toner image on the sheet 25. The image forming unit 15C forms a cyan toner image on the sheet 25. The image forming unit 15K forms a black toner image on the sheet 25. A color image is formed on the sheet 25 which has passed through the image forming units 15Y to 15K.

A fixing unit 30 heats the sheet 25, and fixes the color image onto the sheet 25. The fixing unit 30 includes a heating roller 30a and a pressurizing roller 30b. A sheet discharge roller 31 causes the sheet 25, which has passed through the fixing unit 30, to move to a sheet discharge tray 32.

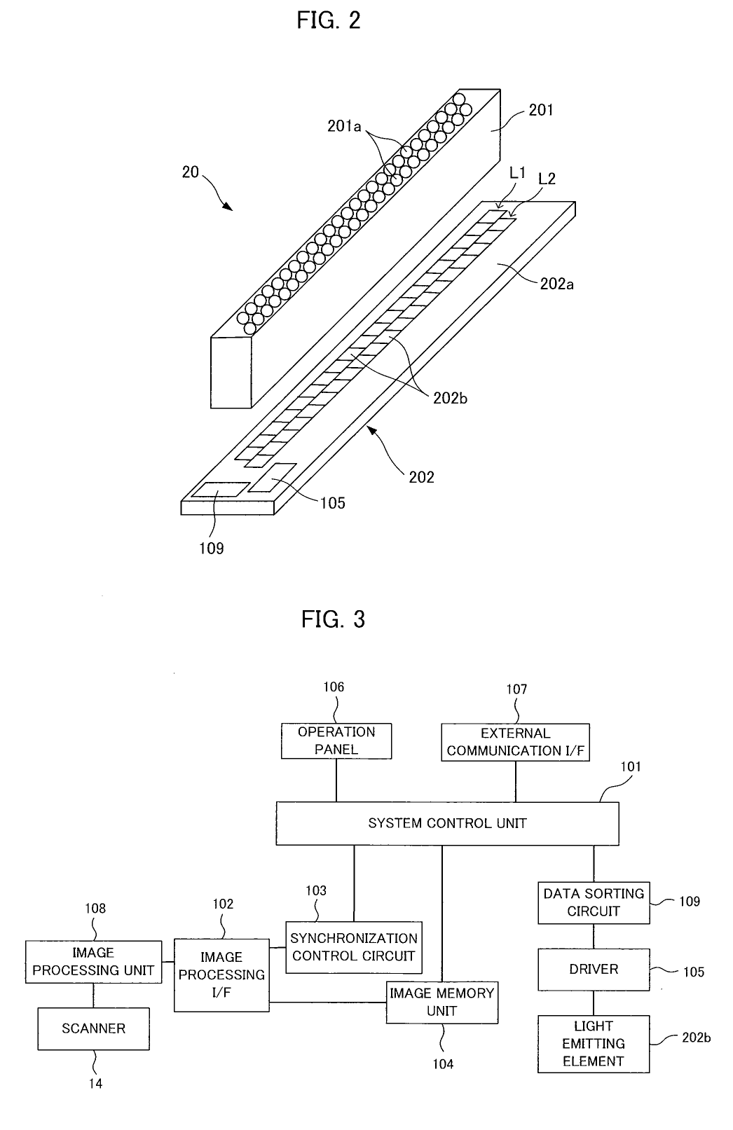

FIG. 2 is a diagram which shows the appearance of the optical print head 20. The optical print head 20 includes a micro lens array 201 and a light emitting panel 202. The micro lens array 201 includes a plurality of micro lenses 201a. The light emitting panel 202 includes a substrate 202a and a plurality of light emitting elements 202b. The substrate 202a is extended in one direction.

The plurality of light emitting elements 202b are arranged along the longitudinal direction of the substrate 202a, and constitutes two element rows (a first element row L1 and a second element row L2). The first element row L1 includes a plurality of light emitting elements 202b which is arranged along the longitudinal direction of the substrate 202a. The second element row L2 includes light emitting elements 202b which is arranged along the longitudinal direction of the substrate 202a.

The extending direction of the first element row L1 and the second element row L2 corresponds to the direction of a rotation axis of the photoconductor 18.

The first element row L1 and the second element row L2 are aligned in the direction orthogonal to the longitudinal direction of the substrate 202a. The first element row L1 and the second element row L2 are deviated from each other in the longitudinal direction of the substrate 202a. The light emitting elements 202b which are included in the second element row L2 are adjacent to two light emitting elements 202b which are included in the first element row L1.

A plurality of micro lenses 201a is provided to correspond to the plurality of light emitting elements 202b. The arrangement of the plurality of micro lenses 201a is the same as that of the plurality of light emitting elements 202b. The light which is emitted from the light emitting element 202b reaches the photoconductor 18, by passing through the corresponding micro lens 201a.

FIG. 3 is a diagram which shows a circuit configuration of an image forming apparatus 100.

A system control unit 101 controls the entire operation of the image forming apparatus 100. The system control unit 101 is connected to a synchronization control circuit 103, an image memory unit 104, a data sorting circuit 109, an operation panel 106, and an external communication I/F 107.

An operation panel 106 is used to input a variety of information to the image forming apparatus 100. A user can input a variety of information by operating the operation panel 106. The external communication I/F 107 is used to perform communication with external equipment.

An image processing unit 108 converts an analog signal which is generated by the photoelectric conversion element 9 (scanner 14) to a digital signal. The image processing unit 108 performs a variety of correction processing with respect to the output signal from the photoelectric conversion element 9. As the correction processing, for example, there is a shading correction or a distortion correction. The digital image data generated by the image processing unit 108 is sent to the image processing I/F 102.

Image processing I/F 102 writes digital image data in the image memory unit 104, in synchronization with a clock signal from the synchronization control circuit 103. The system control unit 101 reads out the digital image data which is written in the image memory unit 104.

When driving the optical print head 20, the system control unit 101 outputs the image data which is read out from the image memory unit 104 to a data sorting circuit 109. The output signal from the data sorting circuit 109 is input to a driver 105. The driver 105 drives the light emitting element 202b. The optical print head 20 has a plurality of light emitting elements 202b. The system control unit 101 controls the amount of luminescence of each light emitting element 202b according to the image data.

The driver 105 and the data sorting circuit 109 are attached to the substrate 202a of the optical print head 20 (refer to FIG. 2).

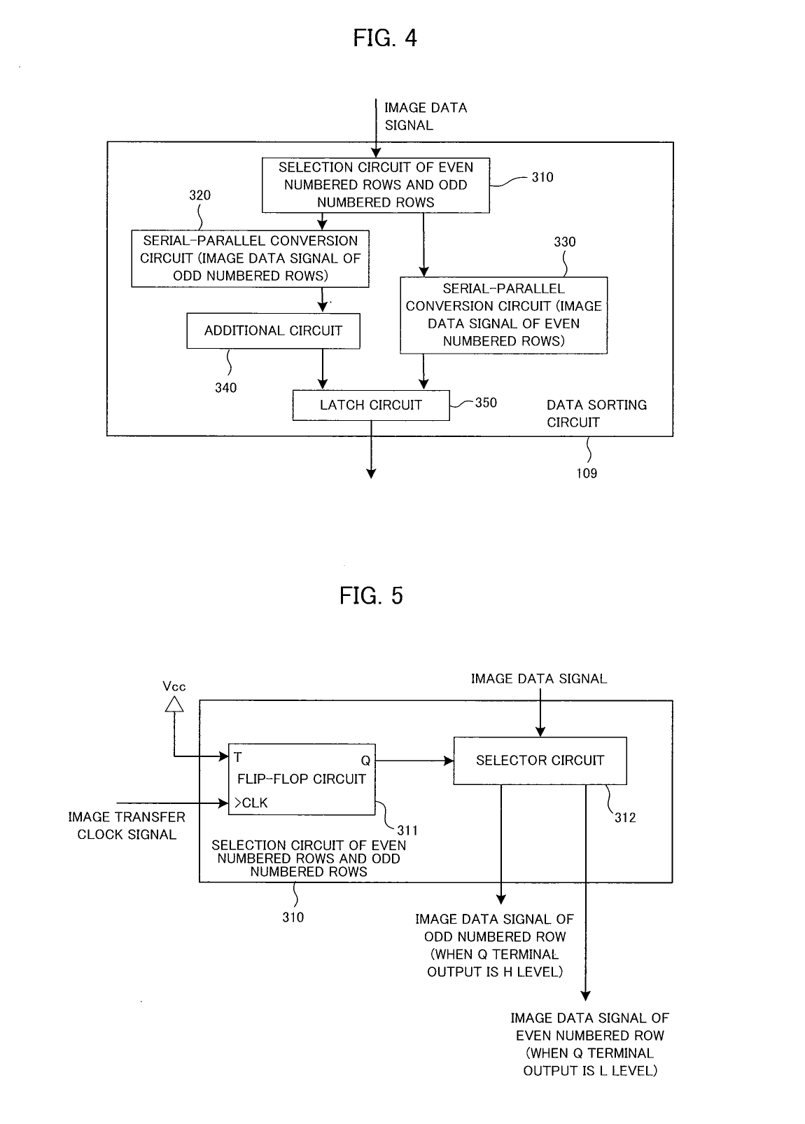

FIG. 4 is a diagram which shows a configuration of the data sorting circuit 109.

A selection circuit of even numbered rows and odd numbered rows 310 receives an image data signal which is transmitted from the system control unit 101. The selection circuit of even numbered rows and odd numbered rows 310 divides the image data signal into an image data signal of odd numbered rows and an image data signal for even numbered rows. The image data signal of the odd numbered rows is a signal for driving the light emitting element 202b of the first element row L1 in FIG. 2. The image data signal for the even numbered rows is a signal for driving the light emitting element 202b of the second element row L2 in FIG. 2.

The selection circuit of even numbered rows and odd numbered rows 310 outputs the image data signal of odd numbered rows to a serial-parallel conversion circuit 320. The selection circuit of even numbered rows and odd numbered rows 310 outputs the image data signal of even numbered rows to a serial-parallel conversion circuit 330. The serial-parallel conversion circuits 320 and 330 convert the input image data signal (serial data) to parallel data.

It is possible to generate a signal for driving each of the light emitting elements 202b which constitute the first element row L1, by converting the image data signal of the odd numbered rows to the parallel data from serial data. It is possible to generate a signal for driving each of the light emitting elements 202b which constitute the second element row L2, by converting the image data signal of the even numbered rows to the parallel data from serial data.

The serial-parallel conversion circuit 320 outputs the image data signal of the odd numbered rows (parallel data) to the additional circuit 340. The additional circuit 340 adds 0 data to the image data signal of the odd numbered rows. The 0 data is data which shows that there is no image.

A latch circuit 350 outputs an image data signal which is output from the additional circuit 340 and an image data signal which is output from the serial-parallel conversion circuit 330 to a driver 105 (refer to FIG. 3).

FIG. 5 shows a configuration of the selection circuit of even numbered rows and odd numbered rows 310. The selection circuit of even numbered rows and odd numbered rows 310 includes a flip-flop circuit 311 and a selector circuit 312.

When printing starts, an H level signal is input to T terminal of the flip-flop circuit 311. An image transmission clock signal is input to a CLK terminal of the flip-flop circuit 311. When the input signal of the T terminal is H level, an output signal of Q terminal is changed from L level to H level, or changed from the H level to the L level, every time the input signal of the CLK terminal is changed from L level to H level.

The output signal of the Q terminal of the flip-flop circuit 311 is input to the selector circuit 312. The selector circuit 312 outputs the image data signal of odd numbered rows among the input image data signals, when the output signal of the Q terminal is H level. The selector circuit 312 outputs the image data signal of even numbered rows among the input image data signals, when the output signal of the Q terminal is L level.

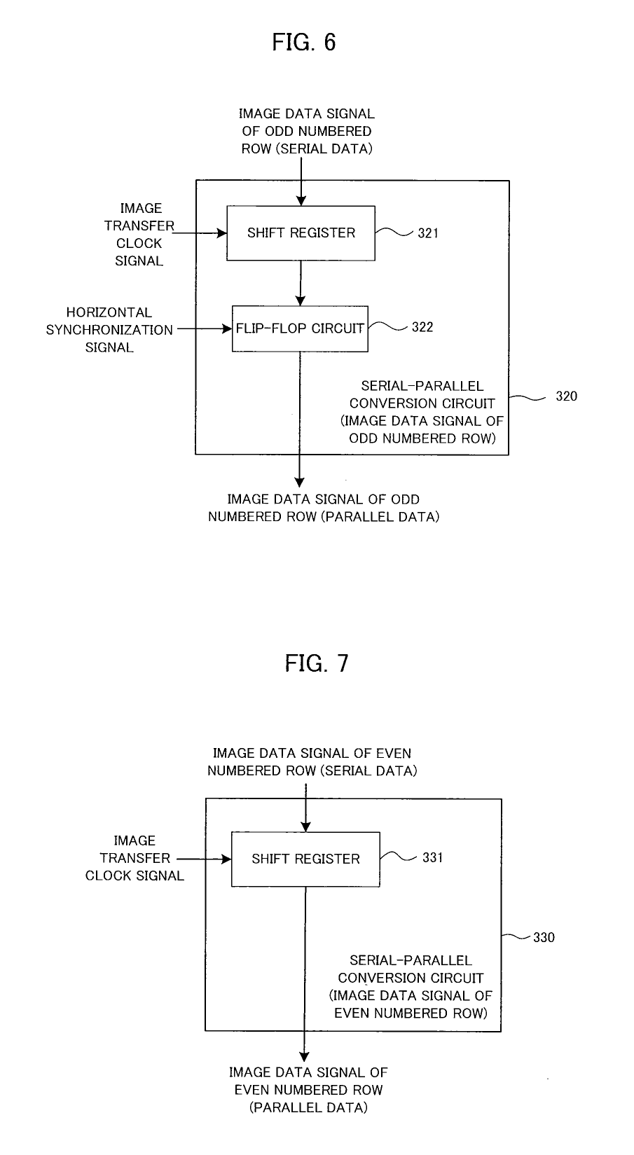

FIG. 6 shows a configuration of the serial-parallel conversion circuit 320. The serial-parallel conversion circuit 320 includes a shift register 321 and a flip-flop circuit 322.

The image transmission clock signal and the image data signal of odd numbered rows are input to the shift register 321. The shift register 321 converts the image data signal (serial data) to parallel data, and outputs the parallel data to the flip-flop circuit 322 according to the image transmission clock signal.

The image data signal (parallel data) and a horizontal synchronization signal are input to the flip-flop circuit 322. When the horizontal synchronization signal is H level, the flip-flop circuit 322 outputs the input image data signal. When the horizontal synchronization signal is L level, the flip-flop circuit 322 maintains the input image data signal. The maintained image data signal is output from the flip-flop circuit 322 when the horizontal synchronization signal is changed from the L level to the H level.

FIG. 7 shows a configuration of the serial-parallel conversion circuit 330. The serial-parallel conversion circuit 330 has a shift register 331. Image data signals of plural rows (serial data) and the image transmission clock signal are input to the shift register 331.

The shift register 331 converts the image data signal (serial data) to the parallel data, and outputs the parallel data according to the image transmission clock signal.

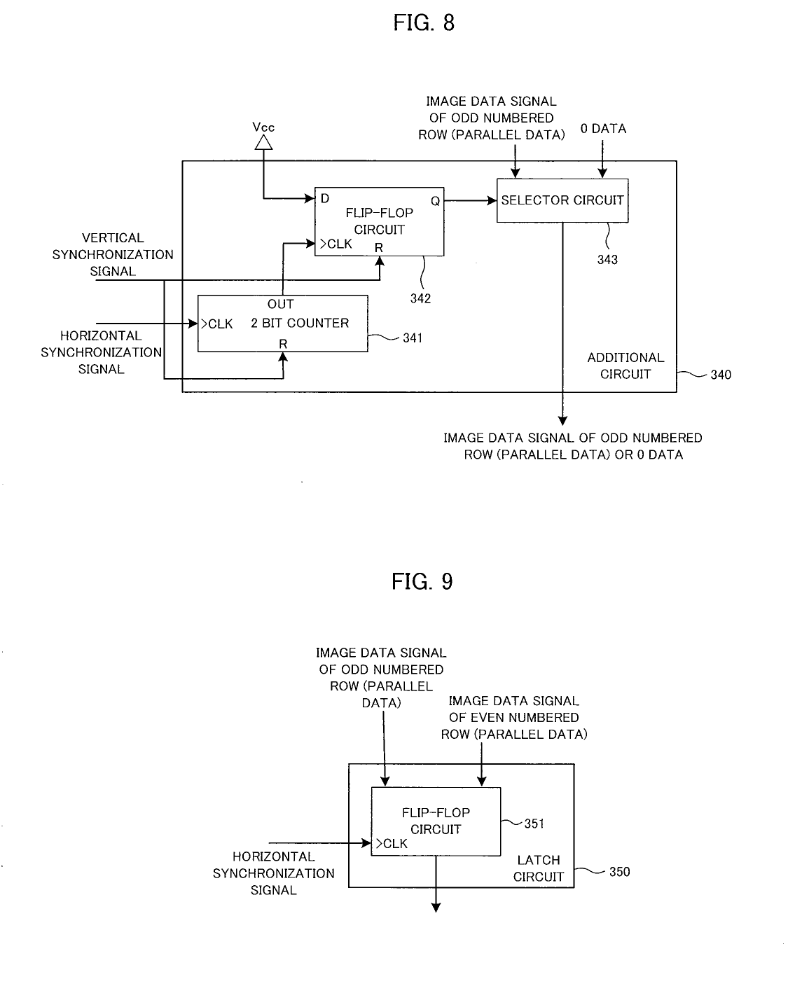

FIG. 8 shows a configuration of the additional circuit 340. The additional circuit 340 includes a 2-bit counter 341, a flip-flop circuit 342, and a selector circuit 343.

A vertical synchronization signal is input to R terminal of the 2-bit counter 341 and R terminal of the flip-flop circuit 342. The horizontal synchronization signal is input to the CLK terminal of the 2-bit counter 341.

The 2-bit counter 341 counts a clock which is input to the CLK terminal, and sets the output signal of OUT terminal to H level, when the counted value becomes 2. The output signal of the OUT terminal remains as L level until the counted value becomes 2. The output signal of the 2-bit counter 341 is input to the CLK terminal of the flip-flop circuit 342.

If the vertical synchronization signal is input to the R terminal of the 2-bit counter 341, the counted value is reset.

When printing starts, the H level signal is input to D terminal of the flip-flop circuit 342. When the H level signal is input to the CLK terminal of the flip-flop circuit 342, the flip-flop circuit 342 outputs the H level signal from the Q terminal. When the vertical synchronization signal is input to the R terminal of the flip-flop circuit 342, the output signal of the Q terminal of the flip-flop circuit 342 becomes L level.

The 0 data and the image data signal (parallel data) of odd numbered rows are input to the selector circuit 343. The selector circuit 343 selects and outputs the 0 data, when the output signal of the Q terminal of the flip-flop circuit 342 is L level. The selector circuit 343 selects and outputs the image data signal of odd numbered rows, when the output signal of the Q terminal of the flip-flop circuit 342 is H level.

FIG. 9 shows a configuration of a latch circuit 350. The latch circuit 350 has a flip-flop circuit 351.

The image data signal of odd numbered rows, the 0 data, and the image data signal of even numbered rows are input to the flip-flop circuit 351. The horizontal synchronization signal is input to the CLK terminal of the flip-flop circuit 351.

The flip-flop circuit 351 maintains the input 0 data, the image data signals of even numbered rows and odd numbered rows, and outputs the maintained data according to the horizontal synchronization signal. When starting the printing of the image, the flip-flop circuit 351 outputs the 0 data and the image data signal of even numbered rows. Subsequently, the flip-flop circuit 351 outputs the image data signals of even numbered rows and odd numbered rows, when the horizontal synchronization signal is changed from L level to H level.

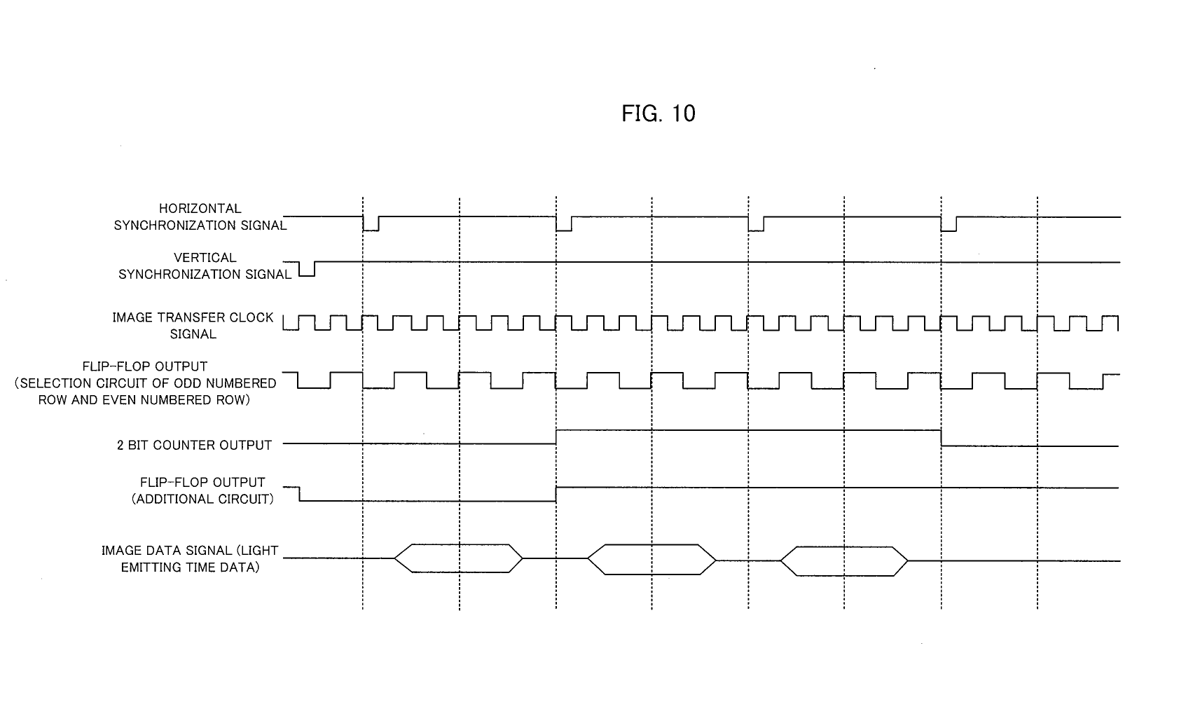

FIG. 10 shows a timing chart when the data sorting circuit 109 operates.

When the output signal of the flip-flop circuit 311 is H level, the image data signal of odd numbered rows is selected among the image data signals which are input to the selection circuit of even numbered rows and odd numbered rows 310. When the output signal of the flip-flop circuit 311 is L level, the image data signal of even numbered rows is selected among the image data signals which are input to the selection circuit of even numbered rows and odd numbered rows 310.

In the additional circuit 340, when the output signal of the flip-flop circuit 342 is L level, the selector circuit 343 outputs the 0 data and the image data signal of even numbered rows. The selector circuit 343 outputs the image data signal of odd numbered rows and even numbered rows, when the output signal of the flip-flop circuit 342 is H level.

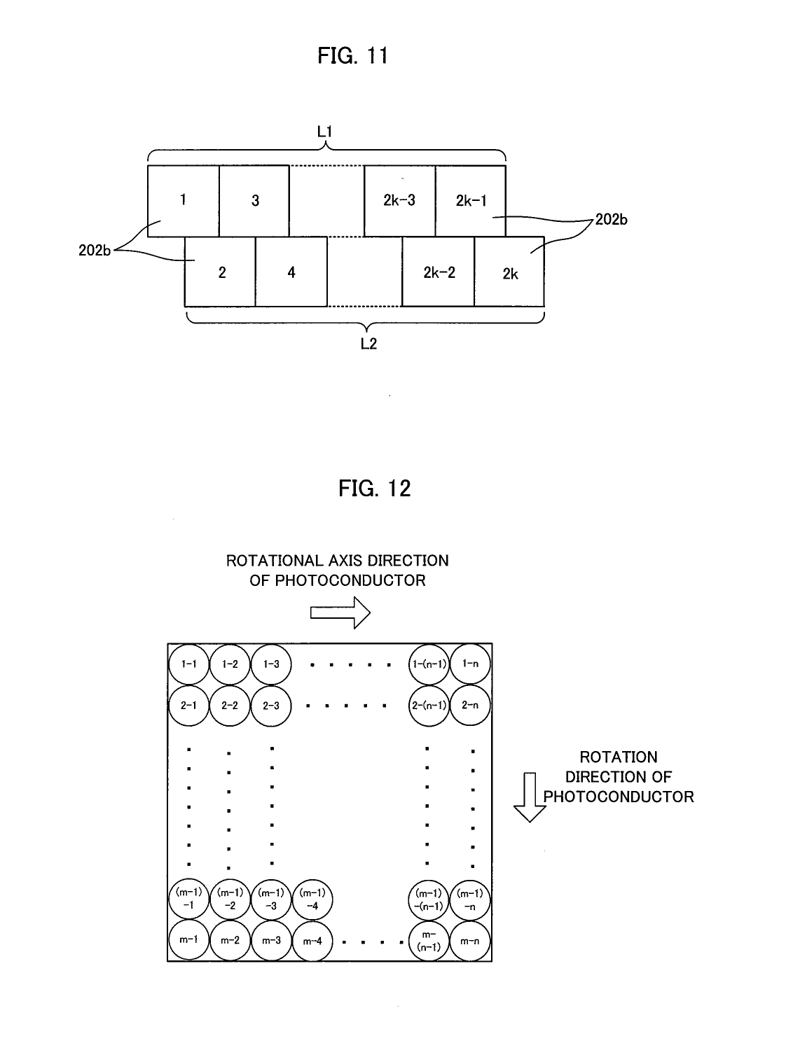

FIG. 11 shows an arrangement of the plurality of light emitting elements 202b. A number is given to each of the light emitting elements 202b in FIG. 11.

FIG. 12 shows an exposure region of the photoconductor 18 due to light emitting of the light emitting element 202b. Exposure regions of 1-1 to m-n are formed in the photoconductor 18 due to the light emitting of the light emitting element 202b of the first element row L1 and the second element L2. The n is the number (2k) of the light emitting element 202b shown in FIG. 11. The m is the number of times of light emitting of the optical print head 20.

The horizontal direction of FIG. 12 is the direction of the rotation axis of the photoconductor 18, and the horizontal direction in FIG. 12 is the rotation direction of the photoconductor 18.

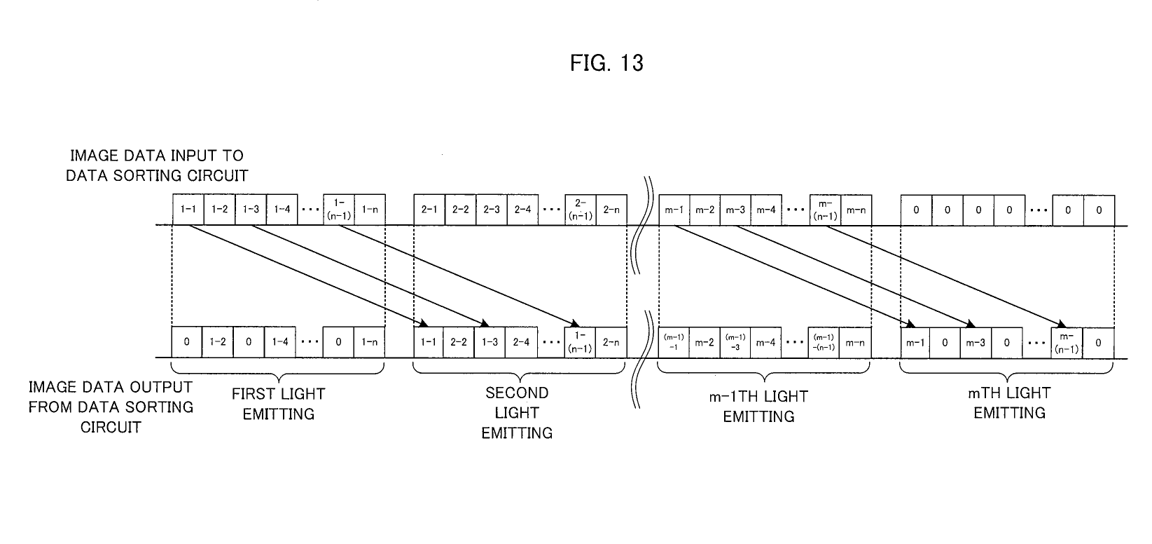

FIG. 13 shows an image data signal which is input to the data sorting circuit 109, and an image data signal which is output from the data sorting circuit 109. The number of image data shown in FIG. 13 corresponds to the exposure region shown in FIG. 12.

When causing the optical print head 20 to emit light for the first time, the light emitting elements 202b of the first element row L1 do not emit light, and only the light emitting elements 202b of the second element row L2 emit light. In the first light emitting, only the regions 1-2, . . . 1-n are exposed, in FIG. 12.

The second light emitting element 202b shown in FIG. 11 emits light which corresponds to image data 1-2 shown in FIG. 13. The fourth light emitting element 202b shown in FIG. 11 emits light which corresponds to image data 1-4 shown in FIG. 13. The 2 kth light emitting element 202b shown in FIG. 11 emits light which corresponds to image data 1-n shown in FIG. 13.

When causing the optical print head 20 to emit light for the second time, the light emitting element 202b of the first element row L1 and the second element row L2 emit light. In the second light emitting, the regions 1-1, 2-2, 1-3, 2-4, . . . 1-(n-1), 2-n are exposed, in FIG. 12.

The first light emitting element 202b shown in FIG. 11 emits light which corresponds to image data 1-1 shown in FIG. 13. The second light emitting element 202b emits light which corresponds to image data 2-2 shown in FIG. 13.

The third light emitting element 202b emits light which corresponds to image data 1-3 shown in FIG. 13. The (2k-1)th light emitting element 202b emits light which corresponds to image data 1-(n-1) shown in FIG. 13. The 2 kth light emitting element 202b emits light which corresponds to image data 2-n shown in FIG. 13.

When causing the optical print head 20 to emit light for the m-1th time, the light emitting element 202b of the first element row L1 and the second element row L2 emit light. In the m-1th light emitting, in FIG. 12, the regions (m-1)-1, m-2, (m-1)-3, m-4, . . . (m-1)-(n-1), and m-n are exposed.

The first light emitting element 202b shown in FIG. 11 emits light which corresponds to image data (m-1)-1 shown in FIG. 13. The second light emitting element 202b emits light which corresponds to image data m-2 shown in FIG. 13. The third light emitting element 202b emits light which corresponds to image data (m-1)-3 shown in FIG. 13. The (2k-1)th light emitting element 202b emits light which corresponds to image data (m-1)-(n-1) shown in FIG. 13. The 2kth light emitting element 202b emits light which corresponds to image data m-n shown in FIG. 13.

When causing the optical print head 20 to emit light for the mth time, only the light emitting element 202b of the first element row L1 emits light. The data sorting circuit 109 does not output image data signals of even numbered rows. In the mth light emitting, in FIG. 12, the regions m-1, m-3, . . . . m-(n-1) are exposed.

The first light emitting element 202b shown in FIG. 11 emits light which corresponds to image data m-1 shown in FIG. 13. The third light emitting element 202b emits light which corresponds to image data m-3 shown in FIG. 13.

The (2k-1)th light emitting element 202b emits light which corresponds to image data m-(n-1) shown in FIG. 13.

As shown in FIG. 13, image data for causing the light emitting element 202b of the first element row L1 to emit light and image data for causing the light emitting element 202b of the second element row L2 to emit light are output from the data sorting circuit 109 at different timings from each other. Even when a plurality of light emitting elements 202b is arranged as shown in FIG. 11, it is possible to expose the photoconductor 18 as shown in FIG. 12.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An optical print head comprising:
a first element row in which a plurality of light emitting elements aligns in a predetermined direction;
a second element row in which a plurality of light emitting elements aligns in a predetermined direction, which aligns with the first element row in a direction orthogonal to the predetermined direction, and deviates in the predetermined direction with respect to the first element row;
a data sorting circuit which outputs image data which corresponds to an exposure region which is formed on a photoconductor due to light emitting of the first element row, and image data which corresponds to an exposure region which is formed on the photoconductor due to light emitting of the second element row, at timings which are different from each other; and
a driver which drives the light emitting elements in the first element row and the second element row, by receiving an output from the data sorting circuit.

2. The print head according to claim 1,
wherein the predetermined direction corresponds to a direction of a rotation axis of the photoconductor.

3. The print head according to claim 1, further comprising:
a lens which receives light beams emitted from the first element row and the second element row, and forms an image on the photoconductor.

4. The print head according to claim 3,
wherein the lens includes a plurality of micro lenses which corresponds to the light emitting elements of the first element row and the second element row.

5. The print head according to claim 1,
wherein the data sorting circuit divides image data which is a printing target into image data which corresponds to the first element row and image data which corresponds to the second element row.

6. The print head according to claim 1,
wherein the light emitting element of the second element row aligns with the two light emitting elements which are included in the first element row, in a direction orthogonal to the predetermined direction.

7. The print head according to claim 1,
wherein when the optical print head emits light for the first time, the data sorting circuit outputs data which shows that there is no image, with respect to the first element row.

8. The print head according to claim 7,
wherein when the optical print head finally emits light, the data sorting circuit outputs data which shows that there is no image, with respect to the second element row.

9. The print head according to claim 1,
wherein the light emitting element is an LED element.

10. The print head according to claim 1,
wherein the light emitting element is an organic EL element.

11. An image forming apparatus comprising:
a first element row in which a plurality of light emitting elements aligns in a predetermined direction;
a second element row in which a plurality of light emitting elements aligns in a predetermined direction, which aligns with the first element row in a direction orthogonal to the predetermined direction, and deviates in the predetermined direction with respect to the first element row;
a data sorting circuit which outputs image data which corresponds to an exposure region which is formed on a photoconductor due to light emitting of the first element row, and image data which corresponds to an exposure region which is formed on the photoconductor due to light emitting of the second element row, at timings which are different from each other;
a driver which drives the light emitting elements in the first element row and the second element row, by receiving an output from the data sorting circuit;
a photoconductor which receives light from the first element row and the second element row, and forms an electrostatic latent image;
a developing unit which supplies toner to the photoconductor, and forms a toner image corresponding to the electrostatic latent image on the photoconductor; and
a transfer unit which transfers the toner image of the photoconductor onto a sheet.

12. The apparatus according to claim 11,
wherein the predetermined direction corresponds to a direction of a rotation axis of the photoconductor.

13. The apparatus according to claim 11, further comprising:
a lens which receives light beams emitted from the first element row and the second element row, and forms an image on the photoconductor.

14. The apparatus according to claim 13,
wherein the lens includes a plurality of micro lenses which corresponds to the light emitting elements of the first element row and the second element row.

15. The apparatus according to claim 11,
wherein the data sorting circuit divides image data which is a printing target into image data which corresponds to the first element row and image data which corresponds to the second element row.

16. The apparatus according to claim 11,
wherein the light emitting element of the second element row aligns with the two light emitting elements which are included in the first element row, in a direction orthogonal to the predetermined direction.

17. The apparatus according to claim 11,
wherein when the optical print head emits light for the first time, the data sorting circuit outputs data which shows that there is no image, with respect to the first element row.

18. The apparatus according to claim 17,
wherein when the optical print head emits light lastly, the data sorting circuit outputs data which shows that there is no image, with respect to the second element row.

19. An exposure method of a photoconductor comprising:
emitting light from a first element row in which a plurality of light emitting elements aligns in a predetermined direction;
emitting light from a second element row in which a plurality of light emitting elements aligns in a predetermined direction, which aligns with the first element row in a direction orthogonal to the predetermined direction, and deviates in the predetermined direction, with respect to the first element row;
outputting image data which corresponds to an exposure region which is formed on a photoconductor due to light emitting of the first element row, and image data which corresponds to an exposure region which is formed on the photoconductor due to light emitting of the second element row, at timings which are different from each other; and
driving the light emitting elements in the first element row and the second element row according to the output image data.
